(19) United States
(12) Patent Application Publication
(10) Pub. No.: US 2026/0242551 A1
(43) Pub. Date: Aug. 20, 2026

(54) METHOD FOR PREPARING POLY-BETA-HYDROXYALKANOATE FILMS

(71) Applicants: CENTRE NATIONAL DE LA RECHERCHE SCIENTIFIQUE, Paris (FR); UNIVERSITE GRENOBLE ALPES, Saint Martin D'heres (FR); INSTITUT POLYTECHNIQUIE DE GRENOBLE, Grenoble (FR)

(72) Inventors: Olivier TRAMIS, Eaubonne (FR); Nadia EL KISSI, Grenoble (FR); Denis ROUX, Corenc (FR)

(21) Appl. No.: 18/993,291

(22) PCT Filed: Jul. 11, 2023
(86) PCT No.: PCT/EP2023/069119

§ 371 Date: Jan. 10, 2025

(30) Foreign Application Priority Data
Jul. 13, 2022 (FR) FR2207238

(51) Int. Cl. C08J 5/18; C08J 3/05

(52) U.S. Cl. CPC C08J 5/18; C08J 3/05; C08J 2367/04

(57) ABSTRACT

A method for preparing a PHA film, including the steps of: a) mixing a PHA in powder form and an aqueous solution in order to obtain a PHA suspension, b) leaving the PHA suspension to rest, by means of which a portion of the PHA settles out and a pellet is obtained, above which floats a supernatant, c) collecting at least part of the supernatant, d) applying the collected supernatant to at least one flat horizontal portion of a surface of a first substrate, e) evaporating the water from the applied supernatant, f) heating at least one region of the portion of the surface of the first substrate to which the supernatant was applied, to obtain a first substrate having at least one region covered with a PHA film. PHA films from 1 to 60 μm thick can be obtained using this method.

The present invention relates to a method for preparing poly-β-hydroxyalkanoate (PHA) film that can be used in particular for manufacturing packaging based on paper or cardboard.

Developing packaging coming from biosourced and recyclable materials is required for environmental reasons. In this context, PHA is an interesting biosourced and recyclable film-forming material. Generally, PHA powder is biosourced, produced by bacteria.

PHA can be transformed into film by depositing a PHA solution in an organic solvent on a substrate. Evaporation of the solvent forms a film. This technique is commonly referred to as “solvent casting”, and makes it possible to obtain very thin films, of the order of 20 microns.

The major drawback of this technology is that PHA is soluble only in chlorinated solvents (i.e. dichloromethane, chloroform), which are highly toxic. Evaporation must take place at relatively high temperatures, of the order of 80° C., over relatively long times, ranging from 8 to 24 hours. Forming PHA films from chlorinated solutions therefore requires specific equipment, in addition to personnel specially trained to handle this type of product. These health constraints give rise to not insignificant extra costs in order to limit the risks of pollution and intoxication of both the handlers and the environment. Finally, it is necessary to ensure that the chlorinated solvent is entirely evaporated from the film in order to ensure non-toxicity for the end user.

Methods for preparing PHA films from aqueous solutions are rare. The application WO 91/13207 describes a method for preparing coated or impregnated paper comprising:
applying to a substrate, in particular a paper, a latex comprising 15 to 25% by weight PHA in water,
evaporating the water from the latex,
heating to form a film by melting of the PHA.

This latex is a colloidal suspension of PHA in water, the PHA particles having a diameter of 0.2 to 1.5 μm.

However, this method leads to obtaining thick PHA films, which is a restriction to its use as packaging.

The main difficulty encountered with PHA is the thickness of the films obtained, greater than 100 μm according to the literature. This restricts the industrial use of PHA for manufacturing paper/cardboard packages based on PHA, since the films sought must have a thickness at least 5 times less, i.e. around 20 microns.

Obtaining thick PHA films has two sources: Firstly, the PHA granules commercially available generally have a mean diameter of 0.5 to 2 mm and melting them leads to the formation of thick films. Secondly, the methods for producing films by injection or extrusion of PHA also lead to thick films.

There is a need to develop thinner PHA films that can be obtained by a method not using chlorinated solvent.

For this purpose, the invention relates to a method for preparing a PHA film comprising the steps consisting in:
a) mixing a PHA in powder form with the following formula (I):

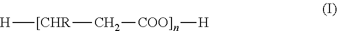

wherein
   each R represents independently a linear or branched alkyl comprising from 1 to 12 carbon atoms,
   n is an integer number greater than or equal to 2 representing the number of units in the PHA,
with an aqueous solution to obtain a suspension comprising from 0.5 to 15% by weight, preferably from 3 to 10% by weight, PHA with respect to the weight of aqueous solution,
b) leaving the PHA solution to rest, generally for 10 seconds to 16 hours, by means of which a portion of the PHA settles out and a pellet is obtained, above which floats a supernatant comprising from 0.1 to 1.0% by weight PHA with respect to the weight of aqueous solution,
c) collecting at least part of the supernatant,
d) applying the collected supernatant to at least one flat horizontal portion of a surface of a first substrate,
e) evaporating the water from the applied supernatant,
f) simultaneously with step e) or after step e), heating at least one region of the portion of the surface of the first substrate to which the supernatant was applied, at a temperature preferably:
   higher than the (specific melting point of PHA+5° C.), preferably higher than the (specific melting point of PHA+15° C.), and
   lower than the (degradation temperature of PHA−10° C.),
by means of which a first substrate is obtained having said at least one region covered with a PHA film.

The method comprises a step a of mixing a PHA and an aqueous solution to obtain a suspension.

This mixing can be done by any method, for example by magnetic stirring or ultrasound.

The PHA used at step a) has the following formula (I):

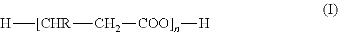

wherein
   each R represents independently a linear or branched alkyl comprising from 1 to 12 carbon atoms, in particular from 1 to 6 carbon atoms, preferably from 1 to 3 carbon atoms, and
   n is an integer number greater than or equal to 2 representing the number of units in the PHA.

The PHA may be a homopolymer. In this case, the R groups of all the units of the polymer are identical. Examples of homopolymers are PHB (poly(β-hydroxybutyrate)) (R then representing a methyl) and PHV (poly(β-hydroxyvalerate)) (R then representing an ethyl).

The PHA may be a copolymer. In this case, the PHA comprises at least two Rs different from each other. For example, the PHBV is a copolymer of poly(β-hydroxybutyrate) and poly(β-hydroxyvalerate). Preferably, the PHA is a copolymer of poly(β-hydroxybutyrate and poly(β-hydroxyvalerate comprising from 1 to 20% by weight hydroxyvalerate units.

PHA is used in powdery form, with a mean particle diameter typically of 0.1 to 1 μm as measured by electron microscopy (SEM). Such a PHA is available commercially, for example from NaturePlast under the reference PHI 003.

Use of PHA granules with a mean diameter of 0.5 to 2 mm as measured by light diffraction at step a) is to be proscribed since they do not allow the formation of a supernatant when the suspension is left to rest at step b). The granules are too large and settle out, and the concentration of PHA in the supernatant is then zero or almost zero.

Mixing from 0.5 to 15% by weight (with respect to the weight of aqueous solution) of a PHA in powder form with an aqueous solution results in the formation of a suspension able to form a supernatant comprising from 0.1 to 1% by weight (from 1 g/L to 10 g/L, knowing that 1% by mass represents 10 g/L for water) of PHA with respect to the weight of aqueous solution, when the suspension is left to rest.

The aqueous solution used at step a) is generally free from chlorinated solvent, preferably free from organic solvent. Preferably, the method does not use chlorinated solvent and, particularly preferably, it does not use organic solvent.

The advantage of the method is the use of water as solvent (in this case as non-solvent, since the PHA is insoluble in water). This involves the absence of risks of poisoning for the users (handlers, consumers) and of risks of environmental pollution and a substantial reduction in production costs compared with the methods using chlorinated solvents.

The aqueous solution used can comprise one or more components selected from:
polymers, for example polysaccharides, such as pectin,
surfactants, preferably biosourced surfactants, and/or
salts, in particular alkaline-ion, alkaline-earth or metal salts, for example calcium or magnesium ions.

Preferably, the solubility in water of the (or of each of the components when there are several of them) is greater than 1 g/L at 25° C. The use of a component soluble in water is preferred so that they are distributed homogeneously in the PHA film formed at the end of the method.

The presence of ions may impact the degree of crystallinity of the PHA film obtained by the method. Preferably, the degree of crystallinity is less than or equal to 40%. An amorphous PHA film is in fact preferred since it is more flexible.

The presence of ions may also impact the sedimentation kinetics during step b).

Generally, monovalent ions influence neither the sedimentation kinetics of the PHA nor the size of the PHA particles. On the other hand, divalent ions, such as magnesium (Mg²⁺) and calcium (Ca²⁺) accelerate the sedimentation of PHA and may modify the size of the PHA particles. Finally, a combination of divalent and monovalent ions gives results similar to those presented. Whatever the ions, it is preferable to use only concentrations of ions of less than 0.01 M. Beyond this, a deposit of ions may form, which is liable to greatly modify the mechanical and barrier properties of the PHA film.

Preferably, the solution used at step a) is water, for example tap water, demineralized water or mineral water.

It is difficult, or even almost impossible, to prepare suspensions of PHA having PHA contents of less than 0.5% by weight with respect to the weight of aqueous solution. This is because, PHA being hydrophobic, putting small quantities of PHA in suspension in aqueous solution leads to the formation of large agglomerates of PHA, which all agglomerate almost immediately to form a pellet with a supernatant almost free from PHA. This is why the method described in the application WO 91/13207 uses a suspension (called latex in the application) of 15 to 25% by weight PHA in water.

However, the inventors discovered that, when a saturated solution of PHA is prepared, i.e. a suspension of 0.5 to 15% by weight PHA with respect to the weight of the aqueous solution, a substantial proportion of the PHA settles out in pellet form, but some of the PHA remains suspended in the supernatant for approximately 16 hours.

The method comprises a step b) where the suspension of PHA is left to rest, by means of which part of the PHA settles out and a pellet is obtained, above which floats a supernatant comprising 0.1 to 1.0% by weight PHA.

The proportion by weight of PHA in the supernatant is generally between 0.1 and 1.0% by weight with respect to the weight of the aqueous solution. It is a case of the proportion of PHA once the rest step b) has been performed, but therefore also a case of the proportion of PHA in the supernatant collected at step c).

The duration of the rest step b) is variable. It is generally from 10 seconds to 16 hours. A duration of less than 10 seconds generally leads to a supernatant the mass concentration of PHA of which will be too high. The film formed at the end of the method will be too thick for the majority of the applications required, in particular for use as packaging. If the suspension is left to rest for more than 16 hours at step b), the proportion by weight of PHA in the supernatant becomes too small and difficult to control.

The duration of step b) depends on the solution used at step a). When demineralized water is used, the duration is preferably from 10 seconds to 16 hours, preferably from 30 seconds to 1 hour, typically from 1 min to 20 min. Some components of the aqueous solution may impact the sedimentation kinetics of the PHA. For example, calcium and/or magnesium ions accelerate it. When an aqueous solution comprising calcium and/or magnesium ions is used at step a), the duration of step b) is preferably from 10 seconds to 30 minutes, typically from 30 seconds to 15 minutes. The appropriate duration for step b) can be determined by studying the sedimentation kinetics in the light of the aqueous solution used, knowing that the duration of step b) must be less than or equal to the duration at the end of which all the PHA has settled out (the concentration of all PHA in the supernatant then being zero).

The diameter D90 of the PHA particles present in the supernatant collected at step c) is generally less than or equal to 40 μm, as measured by light diffraction. The diameter D50 of the PHA particles present in the supernatant collected at step c) is generally less than or equal to 10 μm, as measured by light diffraction.

The method comprises a step c) consisting of collecting at least a portion of the supernatant, and then a step d) consisting in applying the collected supernatant on at least a flat horizontal portion of a surface of a first substrate, then a step e) consisting in evaporating the water of the supernatant applied.

The evaporation step e) can be accelerated by heating, for example by placing the first substrate in an oven, or on a hotplate. The heating temperature is preferably below 100° C. to avoid boiling the water, which would affect the homogeneity of the PHA powder deposited.

After the water is evaporated, a homogeneous powder deposit forms on the part of the surface on which the supernatant was applied. The surface of the first substrate on which the collector supernatant is applied must be flat and horizontal, without which the supernatant flows into the lowest or hollow regions and is not distributed uniformly.

In order to solidify this powder, it is necessary to proceed with a melting step, which makes it possible to form a film with a thickness generally of 10 to 60 μm. The method therefore contains a step f) consisting in heating at least one region of the portion of the surface of the first substrate on which the supernatant was applied, at a temperature preferably:
higher than the (specific melting point of PHA+5° C.), preferably higher than the (specific melting point of PHA+15° C.), and
lower than the (degradation temperature of PHA−10° C.),
by means of which a first substrate is obtained having said at least one region covered with a PHA film.

Preferably, the duration of step f) is less than 5 minutes in order not to degrade the PHA film formed.

Steps e) and f) may be simultaneous. In this case, evaporation and heating are implemented at the same time. The heating temperature can then be above 100° C. The supernatant is then transformed directly into film, without PHA powder being formed. For example, applying a thermopress or a calendering roller to the region of the first substrate makes it possible to implement steps e) and f) simultaneously.

The region of the first substrate heated at step f) may correspond to the whole of the surface on which the supernatant was applied. In this case, the film formed at step f) will have the form of the surface part of the substrate on which the supernatant was applied. All the PHA deposited on the surface is then transformed into film.

Alternatively, the region heated at step f) may be more restricted than the surface portion of the substrate on which the supernatant was applied. The film forms only in the heated region, and the PHA remains in powder form in the non-heated region. Step f) may for example be implemented with a laser, which targets only the required region or regions. This alternative thus makes it possible to obtain patterns.

Advantageously, the PHA film obtained by the method according to the invention has a thickness of 1 to 60 μm, typically from 2 to 50 μm, in particular from 3 to 30 μm, preferably from 5 to 25 μm, as measured by scanning electron microscopy (SEM). Such thicknesses are particularly adapted for packaging. The film is generally transparent when the thickness thereof is less than or equal to 30 μm. It has a slightly brownish color at greater thicknesses.

The method may comprise a step g) consisting in recovering the film, i.e. separating it from the first substrate. It is preferable to leave the film to rest for at least 60 minutes at ambient temperature (of the order of 20° C.) between steps f) and g). This duration enables the PHA of the film to crystallize, which favors detachment thereof from the surface of the first substrate.

Advantageously, the pellet formed at step b) can be used as a source of PHA to form the PHA suspension and to implement the method. Thus there is no loss of material. Thus, in one embodiment, the method comprises the steps consisting in:
a′) after step c), mixing the pellet, optionally with the portion of the supernatant that was not collected at step c), with an aqueous solution to obtain a second suspension comprising from 0.5 to 15% by weight, preferably from 3 to 10% by weight, of PHA with respect to the weight of aqueous solution,
b′) leaving the PHA solution to rest for 10 seconds to 16 hours, by means of which a second pellet is obtained, above which floats a second supernatant comprising from 0.1 to 1.0% by weight PHA with respect to the weight of aqueous solution,
c′) collecting at least a portion of the second supernatant,
d′) applying the collected second supernatant to at least one flat horizontal portion of a surface of a second substrate,
e′) evaporating the water from the second supernatant applied,
f′) simultaneously with step e′) or after step e′), heating at least one region of the portion of the surface of the second substrate to which the second supernatant was applied, preferably at a temperature:
   higher than the (specific melting point of PHA+5° C.), preferably higher than the (specific melting point of PHA+15° C.), and
   lower than the (degradation temperature of PHA−10° C.), by means of which a second substrate is obtained having said at least one region covered with a PHA film.

The embodiments described above and below for the first substrate and for the first supernatant also apply to the second substrate and to the second supernatant.

According to a first alternative of the method, the first substrate is paper or cardboard. At the end of step f), a composite material is obtained consisting of paper or cardboard, at least one region of which is covered with a PHA film.

By means of this film, the paper or cardboard acquires barrier properties (water, oil and/or gas), which makes it particularly suitable for being used as packaging.

This composite material is completely biodegradable into industrial compost. The composite material can serve as a source of food for strains of bacteria producing PHA. It is a virtuous life cycle forming part of a circular, sustainable and responsible economy.

The drawback of using paper or cardboard as the first substrate is that applying the supernatant to at least a portion of the surface thereof during step d) leads to wetting the paper or cardboard, which may degrade some of the properties thereof.

Thus, according to a second alternative of the method, the first substrate is neither paper nor cardboard. Typically, the method then comprises, after step f), a step h) consisting in transferring the PHA film to a substrate with a nature different from the first substrate.

This transfer may comprise the steps consisting in:
h1) heating the first substrate, said at least one region of which is covered with a PHA film,
h2) placing at least a portion of the surface of a substrate with a nature different from the first substrate on the PHA film so as to obtain a multilayer material in which the film is located between the first substrate and a substrate with a nature different from the first substrate,
h3) removing the first substrate from the multilayer material, by means of which a substrate is obtained with a nature different from the first substrate, and at least a portion of the surface of which is covered with a PHA film.

For example, the first substrate is made from glass, from ceramic, from sulfurized or Teflon-coated paper or from metal, and the substrate with a nature different from the first substrate is made from paper or cardboard. Using a first substrate made from sulfurized or Teflon-coated paper is advantageous in that the film is easy to detach, which facilitates recovery thereof.

At the end of the method according to this second alternative, a composite material is therefore also obtained, consisting of paper or cardboard at least a portion of the surface of which is covered with film. The advantages mentioned above remain valid. One additional advantage is that the paper or cardboard has not been wetted during the method.

The following examples illustrate the method according to the invention.

In the examples below, the PHA came from NaturePlast, under the reference PHI 003.

The scanning microscope used is an SEM-FEG Ultra 55, marketed by the company Zeiss.

### Example 1: Method for Preparing a PHA Film on an Aluminum Cup

The following protocol was followed:
Preparing a 5% by weight suspension of PHA in water by mixing 1.5 g of PHA in 30 g of water and stirring the suspension until a homogeneous milky appearance is obtained (step a))
Leaving the suspension to rest for 3 minutes (step b))
Collecting the supernatant (step c))
Depositing the supernatant at the bottom of an aluminum cup (first substrate), until the surface at the bottom of the cup is entirely covered with supernatant (step d))
Leaving to evaporate (e.g.: 6 g of supernatant takes approximately 36 hours to evaporate completely at ambient temperature (20° C.)) (step e))
Alternatively, placing the cup on a hotplate or in an oven to accelerate the evaporation.

Once the supernatant has evaporated, a deposit of white PHA is visible.
Preheating a hotplate to 200° C.
Depositing the cup containing the deposit of PHA on a hotplate for a maximum time of 5 minutes, by means of which a film forms (step f))
Cutting the contours of the cup in order to keep only the bottom on which the film rests
Optionally, recovering the film by removing the bottom of the cup (step g)).

The PHA film obtained was 7.75 μm thick (average over three measurements determined by scanning electron microscope with a magnification of ×500).

### Example 2: Transfer of the Film of Example 1 onto a Paper

The following protocol was followed:
Placing the cup the contours of which were cut and on the bottom of which the film rests on a hotplate stabilized at 200° C. (step h1))
Once the film has melted, depositing paper on the molten film to obtain an aluminum/PHA film/paper multilayer material (step h2)) (the substrate different from the first substrate is therefore paper in this example)
Rolling a roller over the surface of the paper
Removing the aluminum/PHA film/paper multilayer material from the hotplate, and leaving it to cool to ambient temperature (20° C.) for at least 60 minutes (the time for the PHA to crystallize, favoring detachment thereof from the aluminum)
Removing the aluminum to obtain a paper the surface of which is covered with a PHA film (step h3)).

The first three steps simulate the action of a thermopress. In an industrial context, the use of a thermopress or of calendering rollers is favored.

### Example 3: Impact of the Concentration of PHA in the Suspension Prepared at Step a) and of the Duration of Step b) on the Concentration of PHA in the Supernatant

The mass concentration of PHA in the supernatant was determined according to:
the mass concentration of PHA in the suspension prepared at step a, and
the duration of the rest step b) (duration between the preparation of the suspension and the collection of the supernatant).

The results are provided in table 1.

TABLE 1

| | |
|---|---|
| Initial mass concentration of PHA | Duration of step b) |

| in the suspension prepared at | 0 | 3 |
|---|---|---|
| step a) (in % wt PHA) | minutes | minutes |
| 0.5 | 0.24 | 0.11 |
| 1 | 0.43 | 0.17 |
| 3 | 1.55 | 0.34 |
| 5 | 2.1 | 0.36 |
| 10 | 6.3 | 0.8 |

Mass concentration (in % wt PHA with respect to the weight of water) of PHA in the supernatant according to the initial concentration of PHA in the suspension prepared at step a) and the duration of step b).

The results show that the mass concentration of PHA in the supernatant depends on the initial mass concentration of PHA in the suspension prepared at step a).

When the rest step b) is absent (duration of 0 minutes: the supernatant is collected just after the suspension is prepared), the concentration of PHA in the supernatant changes almost linearly with the initial mass concentration of PHA in the suspension prepared at step a).

On the other hand, after three minutes of rest, an identical concentration of PHA of the order of 0.35% by mass (i.e. 3.5 mg/ml) in the supernatant is obtained, whether the initial mass concentration of PHA in the suspension prepared at step a) be 3% or 5% with respect to the weight of aqueous solution.

This means that a suspension having an initial concentration of PHA of 5% by weight can be prepared, the supernatant collected and the pellet reused to re-form a suspension until the concentration in the suspension falls to 3%, without the concentration of PHA in the supernatant being modified.

To demonstrate that the concentration in the supernatant is low, a 5% suspension of PHA by weight was prepared by mixing 1.5 g of PHA with 30 g of water, i.e. a concentration equivalent to 50 mg/ml. In the supernatant, after 3 minutes of rest, the concentration was 3.6 mg/ml, i.e. a concentration 14 times lower.

Obtaining a 3.6 mg/ml suspension of PHA in water would require mixing 85 mg of PHA with 30 g of water. However, the 85 mg of PHA were not able to be mixed homogeneously with water, because of the immiscibility of PHA in water. Such a low concentration of PHA was able to be obtained only by preparing an initially much more concentrated suspension, leaving it to rest and recovering the supernatant.

This demonstrates the advantage of preparing an initially concentrated suspension and then recovering the supernatant to be able to obtain a suspension of PHA at low concentration, which cannot be prepared otherwise.

The PHA films obtained from a 3 or 5% suspension of PHA by weight with respect to the weight of aqueous solution were approximately 10 micrometers thick as measured by SEM.

### Example 4: Size of the PHA Particles in the Supernatant as a Function of the Time of Step b) and of the Mineralization of the Water Used for Preparing the Suspension

The dry PHA powder used as starting product contains agglomerates of particles having sizes ranging from around a hundred microns to sizes less than a micrometer, measured by electron microscopy (SEM).

When the suspension is prepared (step a)), the maximum size of the PHA particles in suspension depends on the mineralization of the water. The more mineral the water, the smaller the size of the PHA particles when the suspension is prepared.

On the other hand, the PHA particles in the supernatant are larger after 3 minutes of rest when mineral water is used.

The size of the particles in the supernatant become independent of the mineralization of the water used as from 5 minutes of rest.

Table 2 provides the change in the maximum size of the particles as a function of the duration of rest of step b) and of the mineralization of the water. The initial concentration of PHA in the suspension prepared at step a) was 5% by weight with respect to the weight of aqueous solution in all cases.

TABLE 2

| | | Tap water | Mineral water |
|---|---|---|---|
| | | (equivalent to | (containing |
| | | demineralized water | 0.1M |
| | | containing 0.01M | (approximately |
| Duration of | | (approximately 0.5 | 2 g/L) |
| rest of | Demineralized | gL) of CaCl₂ | of CaCl₂ |
| step b) (min) | water | dihydrate) | dihydrate) |
| 0 | 140 | 103.5 | 89 |
| 1 | 108.2 | 74.8 | 65 |
| 3 | 12.2 | 7.7 | 35.5 |
| 5 | 10.4 | 10.4 | 10.4 |
| 10 | 10.4 | 12.2 | 8.9 |

Maximum size of the particles in the supernatant obtained from a PHA suspension at 5% wt with respect to the weight of aqueous solution.

These results show that the mineralization of the water impacts the size of the particles, but that, as from a sedimentation time of 5 minutes, it is possible to obtain the same particle size whatever the aqueous solution used. In conclusion, it is possible to add minerals to the PHA solution without having to modify the protocol, which is an advantage in terms of costs and production time.

### Example 5: Sedimentation Kinetics as a Function of the Mineralization of the Water

A suspension was prepared as described at example 1. The suspension was stirred and then placed in a darkroom. The suspension was illuminated uniformly, and photographs were taken at regular intervals of time. On each photograph, the intensity was taken on a vertical line. When the PHA settles out in the pellet, the color changes from white to black, which makes it possible to monitor the sedimentation of the PHA. Each intensity extracted was entered on a graph, where the X-axis represents time and the Y-axis the intensity. This therefore forms a time mapping of the sedimentation. The sedimentation was regular and linear with time, and in accordance with a conventional profile, so called “barometric”, of sedimentation of immiscible solid particles. The sedimentation had ended after 16 to 17 hours.

The experiment was reproduced for a suspension the aqueous phase of which was an aqueous solution of CaCl₂). The protocol of example 1 was followed, except that 0.3 mL of a 1M solution of CaCl₂) was added to the water during step a), making it possible to obtain a suspension of PHA in a 0.1 M aqueous solution of CaCl₂). The sedimentation kinetics was followed in the same way. In this case, the sedimentation ended after 30 minutes.

Adding ions, and in particular “heavy” ions (Ca²⁺, Mg²⁺) accelerates the sedimentation during step b). Without wishing to be bound by any particular theory, the inventors suppose that these ions create a bond between two PHA molecules. The consequence of this is creating larger, and therefore heavier aggregates, therefore setting out more quickly.

The duration of sedimentation therefore depends on the nature of the aqueous solution. The optimal duration of step) also. The supernatant must be collected before sedimentation is total.

What is claimed is:

1. Method for preparing a PHA film comprising the steps of:
a) mixing a PHA in powder form with the following formula (I): 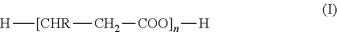
wherein:
each R represents independently a linear or branched alkyl comprising from 1 to 12 carbon atoms,
n is an integer number greater than or equal to 2 representing the number of units in the PHA,
and an aqueous solution to obtain a suspension comprising from 0.5 to 15% by weight, preferably from 3 to 10% by weight, PHA with respect to the weight of aqueous solution,
b) leaving the PHA solution to rest, generally for 10 seconds to 16 hours, by means of which a portion of the PHA settles out and a pellet is obtained, above which floats a supernatant comprising from 0.1 to 1.0% by weight PHA with respect to the weight of aqueous solution,
c) collecting at least part of the supernatant,
d) applying the collected supernatant to at least one flat horizontal portion of a surface of a first substrate,
e) evaporating the water from the applied supernatant,
f) simultaneously with step e) or after step e), heating at least one region of the portion of the surface of the first substrate to which the supernatant was applied, at a temperature preferably:
higher than the (specific melting point of PHA+5° C.), preferably higher than the (specific melting point of PHA+15° C.), and
lower than the (degradation temperature of PHA−10° C.),
by means of which a first substrate is obtained having said at least one region covered with a PHA film.

2. Method according to claim 1, wherein the PHA in powder form used at step a) is such that the mean diameter of PHA particles is from 0.1 to 1 μm as measured by electron microscopy (SEM).

3. Method according to claim 1, wherein the aqueous solution used at step a) comprises one or more components selected from:
polymers, for example polysaccharides, such as pectin,
surfactants, preferably biosourced surfactants, and/or
salts, in particular alkaline-ion, alkaline-earth or metal salts, for example calcium or magnesium ions.

4. Method according to claim 1, wherein the PHA film has a thickness of 1 to 60 μm, typically from 2 to 50 μm, in particular from 3 to 30 μm, preferably from 5 to 25 μm, as measured by scanning electron microscopy.

5. Method according to claim 1, wherein the first substrate is paper or cardboard.

6. Method according to claim 1, comprising, after step f), a step g) comprising recovering the PHA film.

7. Method according to claim 1, comprising, after step f), a step h) comprising transferring the PHA film onto a substrate with a nature different from the first substrate.

8. Method according to claim 7, wherein step h) comprises the steps of:
h1) heating the first substrate, said at least one region of which is covered with a PHA film,
h2) placing at least a portion of the surface of a substrate with a nature different from the first substrate on the PHA film so as to obtain a multilayer material in which the film is located between the first substrate and a substrate with a nature different from the first substrate,
h3) removing the first substrate from the multilayer material, to obtain a second substrate with a nature different from the first substrate, and at least a portion of the surface of which is covered with a PHA film.

9. Method according to claim 7, wherein the first substrate is made from glass, from ceramic, from sulphurized or Teflon-coated paper or from metal, and the second substrate with a nature different from the first substrate is made from paper or from cardboard.

10. Method according to claim 1, comprising the steps of:
a′) after step c), mixing the pellet, optionally with the portion of the supernatant that was not collected at step c), with an aqueous solution to obtain a second suspension comprising from 0.5 to 15% by weight, preferably from 3 to 10% by weight, of PHA with respect to the weight of aqueous solution,
b′) leaving the PHA solution to rest for 10 seconds to 16 hours, by means of which a second pellet is obtained, above which floats a second supernatant comprising from 0.1 to 1.0% by weight PHA with respect to the weight of aqueous solution,
c′) collecting at least a portion of the second supernatant,
d′) applying the collected second supernatant to at least one flat horizontal portion of a surface of a second substrate,
e′) evaporating the water from the second supernatant,
f′) simultaneously with step e′) or after step e′), heating at least one region of the portion of the surface of the second substrate to which the second supernatant was applied, preferably at a temperature:
higher than the (specific melting point of PHA+5° C.), preferably higher than the (specific melting point of PHA+15° C.), and
lower than the (degradation temperature of PHA−10° C.),
by means of which a second substrate is obtained having said at least one region covered with a PHA film.
